(19) United States
(12) Patent Application Publication
(10) Pub. No.: US 2004/0066924 A1
(43) Pub. Date: Apr. 8, 2004

(54) Automated reminder system

(76) Inventor: Shalom Wertsberger, South Portland, ME (US)

Correspondence Address: SALTAMAR INNOVATIONS, 30 FERN LANE, SOUTH PORTLAND, ME, 04106, US

(21) Appl. No.: 10/618,980

(22) Filed: Jul. 14, 2003

Related U.S. Application Data
(60) Provisional application No. 60/403,546, filed on Aug. 14, 2002.

(51) Int. Cl. H04M 3/42

(52) U.S. Cl. 379/201.01

(57) ABSTRACT

A reminder system allowing submission of a reminder and a desired scheduled delivery time or times, associated with a message, and preferably a recorded voice message. At substantially the desired time the system attempts delivery to one or more telephones associated with the person or persons to whom the message is directed. Submission via a telephone and reception of a clear recorded message provide the advantages of similarity simplicity and clarity.

### RELATED APPLICATIONS

This application claims the benefit of priority of U.S. provisional application No. 60/403,546 filed Aug. 14, 2002.

### FIELD OF THE INVENTION

This invention relates generally to automatic reminder systems and more particularly to automated systems for scheduling and sending reminders via telephone.

### BACKGROUND

Maintaining schedules is a hard task for many people, and especially for the elderly. Paper based equipment requires constant checking, and computers require that the person will be at the computer for the reminder. Additionally, the elderly are often reluctant to use computers. Many memory aids exist in the market in the form of calendar watches, cell phones with calendar ability, PDA's (Personal Digital Assistants), and the like. However most portable devices suffer from inconvenient data entry.

In the corporate executive world, such problems are usually solved by a support staff. The busy executive will get a call from a secretary reminding him/her of the pending meeting, timely required actions, etc. The secretary can locate the executive in several probable locations, such as at home, on a cell phone, in a friend's house, etc. This is done in easy to understand and intuitive fashion, as the communication is between two people. However, many people in need of such service cannot afford a private secretary.

Many reminder devices are available via the internet. Most provide e-mail notification at a selected data or date time combination. Some, like the Iping company® in New York N.Y., USA, provides an internet based server where one may enter reminders via web sites, and have messages played back via telephone. An internet site called ‘uremember.com’® (provides similar capabilities. However the Iping solution and the uremember solution both require submittal via a computer, and the Internet. This presents a problem to many elderly people, and others, that do not feel at ease with a computer, or do not have a web enabled device handy, at the time when the reminder is to be submitted.

Additional shortcoming of the internet based service is the reluctance of many to expose their schedule and leave information regarding it in a place outside their control.

Thus there is a clear need or an easy to use system, that will be easily programmable and provide a reminder to a subscriber in a flexible fashion, preferably, under the control of the subscriber. It is a goal of the present invention to provide such a system.

### BRIEF DESCRIPTION

In these specifications the term subscriber refers to the person who receives the reminder. The term submitter refers to the person who enters reminder data to be sent to the subscriber. It should be noted that the subscriber and submitter might be one and the same. A reminder request relates to the submission of reminders, and reminder alert, relates to providing a timely alert for the reminder item. A reminder is directed to an individual or a member of a group of selected individuals.

It is a goal of the present invention to provide a system that allows submitters to enter a reminder request via a telephone. It is further a goal to provide reminder alerts to a plurality of locations or via a plurality of routes according to criteria.

Thus in a preferred aspect of the invention there is provided an automated reminder apparatus comprising a telephone system interface; and an event receiver adapted to receive a plurality of reminder submissions via said telephone system interface. Each submission comprises at least information related to a delivery time and a message, and directed to a subscriber that has at least one telephone device associated therewith. The apparatus also comprises a scheduler adapted to produce an activation signal at said delivery time; and an event dispatcher, coupled to said scheduler and adapted to connect to said telephone device and deliver said message as voice message, responsive to said activation signal.

Preferably, the apparatus further comprises a voice recorder adapted to record the message. Also preferably, the apparatus is constructed to receive one reminder-submission for more than just one person, thus allowing a single message to be addressed to a group of individual subscribers, for purposes such as meeting scheduling, and the like. Scheduling information may be entered by any convenient method, such as voice recognition (i.e. utilizing speech to text conversion technologies), telephone keypad entry, and the like. Optionally the apparatus is constructed to prompt entry of the submission information using voice prompt, such as synthesised or pre-recorded voice prompts. In one embodiment, the invention is adapted to receive reminder submissions, and management information from a data network such as the internet or from a computer coupled thereto. Thus the device may easily receive instructions from a computer in the house or from anywhere in the world over the internet. In the preferable embodiment of the invention, the apparatus can accept scheduling information for repeated sending of same message according to a predetermined schedule.

In the more preferred embodiment, the invention comprises an authentication manager. The authentication manager preferably performs one or more operations such as authenticating the submitter, authenticating, the subscriber, and authenticating the submitter's authority to send the reminder to one or more telephone devices. Such authentication may for example occur by voice recognition or by entering a password from a telephone.

In the most preferred embodiment, an apparatus is constructed to sequentially attempt to deliver the message to each of a plurality of telephone devices associated with the subscriber or with a specific message, until the message is successfully delivered. Optionally, if message delivery fails, a message notifying of the failure is sent to yet another telephone device.

In the most preferred embodiment, the apparatus is constructed with a second telephony interface to couple to at least one telephone at the subscriber premises as well as the first interface to couple to a telephony network such as, but not limited to a telco, cable telephony, wireless, or a PBX network. In such embodiment the apparatus preferably further comprises a ring generator having a ring output, and the apparatus is constructed to apply the ring output to the second telephony interface for delivery of message a telephone within the subscriber premises. In a preferred application of such a system, the second telephony interface is coupled to the telephony wiring inside the user premises and the apparatus is utilized to separate the user premises from the general telco domain. Optionally in such an embodiment, the apparatus further comprises a command interpreter to receive and interpret commands entered from the telephone in the subscriber premises. It would be clearly desired to be able to apply the ring only to the telephone inside the subscriber premises, and thus optimally a telephone line interrupter switch is also provided to separate between the first and second telephony interfaces. For the purposes of the present embodiment, such switch may accomplish an actual circuit disconnect, or comprise a device adapted to filter and capture ring signals, and selectively prevent those signals from reaching a telephone coupled to the second interface. Thus the apparatus may operate on such signals, in such ways such as answering calls, generating rings inside the house, and the like.

It is desirable, and the invention optionally provides for, a network interface, such as an internet interface. Such network interface will allow use of the internet or intranet for configuration, reminder submittal, and possible even serve as telephony interface by using network telephony such as voice over IP, paging services, etc. It is also desirable that the invention is installed outdoors in a weatherproof enclosure, close to where the telephone service enters the house.

As the invention in its preferable forms, contains the necessary equipment to record voice, and to respond to telephone keypad entry, it would advantageously feature the capabilities of an automatic answering device to this aspect of the invention. Those skilled in the art will recognize that having the components available greatly eases the task of providing voice mail capabilities, including the option of remote retrieval, as known. Such answering device will significantly increase the commercial potential of the embodiment.

In yet another aspect of the invention, there is provided a method for providing reminders using a telephone, the method comprising the steps of:

Receiving a reminder submission, comprising at least a desired delivery time, and a message, preferably a recorded voice message, in an apparatus coupled to a telephony network, said submission entered via a telephone, and directed to a subscriber having at least one telephone device associated therewith;

At substantially the desired delivery time, delivering said message to said subscriber via said telephone device. Preferably, a plurality of telephone devices are associated with said subscriber, and the step of delivering further comprises the step of sequentially attempting to deliver said message to each of said plurality of telephone devices, until said message is delivered. IN its most preferred embodiment, the method also comprises the step of generating a ring in the telephones in the subscriber premises, selectively prior to attempting to deliver the message to other telephone numbers. Similar to the capabilities described for the apparatus above, the method optionally provides such features as different input methods for the reminder submission, different scheduling information, and the like, as described for different functions provided by the structure described for the apparatus in any of its embodiments.

### BRIEF DESCRIPTION OF THE DRAWINGS

FIG. 1 depicts an example general overview for a system in accordance with the present invention adapted for operation in a subscriber premises.

FIG. 2 is a simplified preferred flow diagram of reminder submission.

FIG. 3 is a simplified preferred flow diagram of reminder delivery.

FIG. 4 depicts block diagram of main blocks of a preferred embodiment apparatus.

FIG. 5 depicts an example general overview of a system in accordance with a central embodiment of the invention.

FIG. 6 depicts general outline of a preferred embodiment layout.

### DETAILED DESCRIPTION

Several preferred embodiments will now be described. Persons skilled in the art will recognize that often an element described for one embodiment is easily applicable for another.

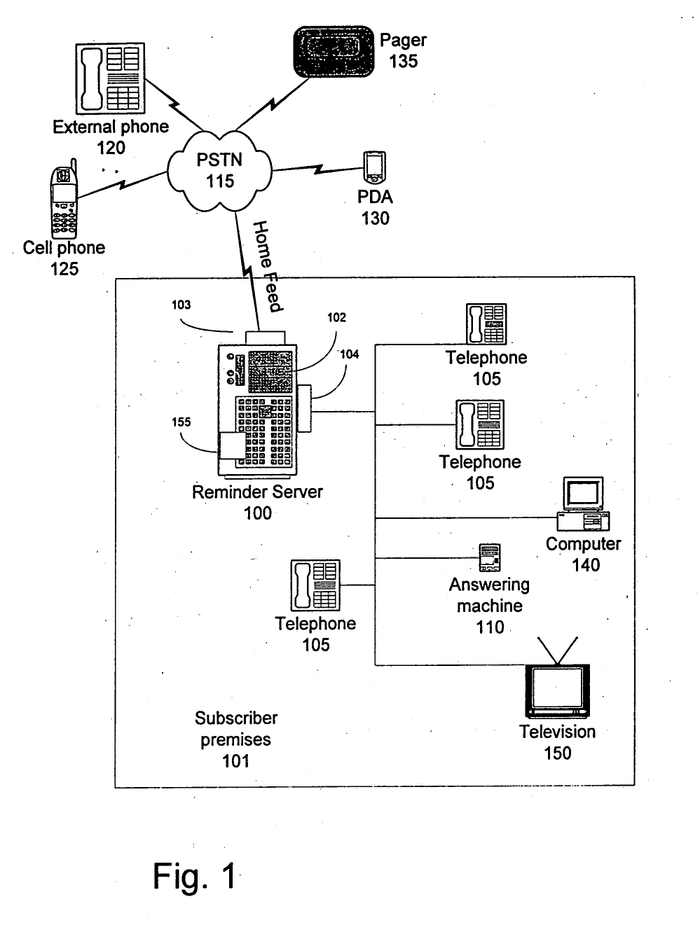

Referring now to FIG. 1 a reminder server 100 is located in the subscriber premises and preferably coupled to the telephony network 115 via the first telephony interface 103 in such a way that it is interposed between the telephony network 115 and the home telephone wiring, which is coupled via a second telephony interface 104 to such as telephone devices 105, optionally to answering machine 110, etc. Optionally, the reminder server may also be coupled to a television 150 for displaying messages (in audio or video, or a combination thereof thereupon. A computer 140 may also be attached to the reminder server, to transmit instructions, facilitate submissions, configuration, and the like of the server, and optionally as yet another message delivery device. It should be noted that the computer does not need to be connected as shown but may be connected via other means and may even be at a remote location to the subscriber premises. The reminder server apparatus is adapted to receive submissions from any convenient source, such as cell phones 125, any phone external to the subscriber premises 120, mobile computers such as PDA 130, internal telephones 105, computer 140, and the like.

In this embodiment, the reminder server also has a telephone interrupter switch 102, adapted to separate the link between the two telephone interfaces 103 and 104. This is needed in order to allow the server 100 to ring telephones in the house using ring generator 155, receive instructions from telephones or other devices in the house, without effecting the public telephony network. It also allows the server to trap calls to the house, if they are identified as directed to the server, without ringing the telephones in the house.

Another option allows the server to communicate with other servers of similar type, to exchange information and derive such features as scheduling information, conflicts and the like. Naturally local networks such as blue tooth and similar interfaces may also be attached to any of the embodiments, for configurations and communications with devices in the house. The apparatus may also be used to schedule and control certain operations of controllable devices in the house.

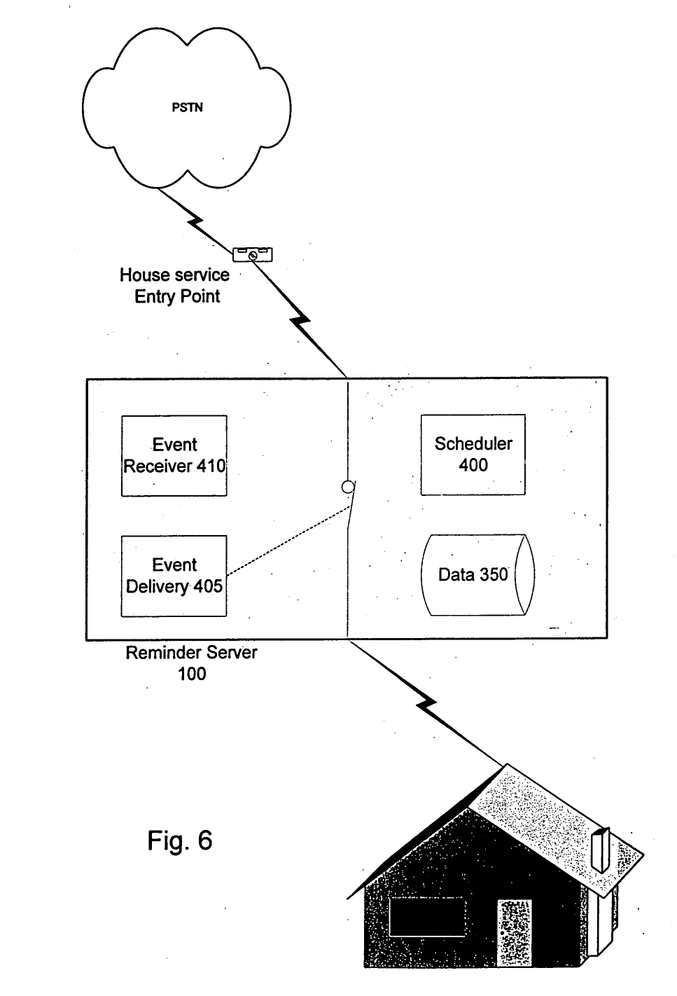

The point where telephone service enters the subscriber premises is a convenient location to place the server. As in many homes this point is exposed to the weather, it is preferable to place such an embodiment in a weatherproof enclosure. This is shown in FIG. 6.

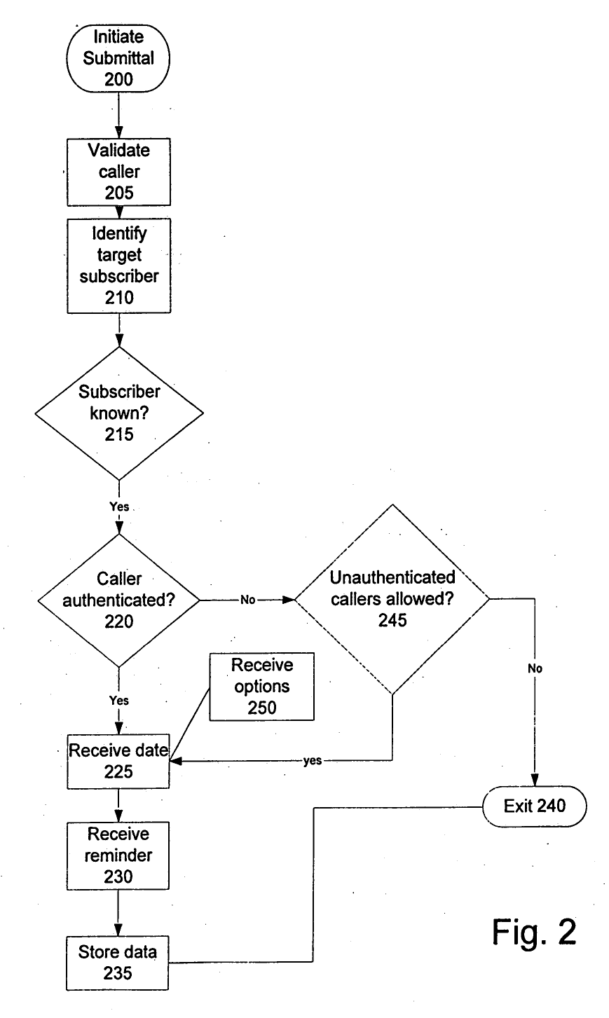

FIG. 2 depicts a simplified flow diagram of the preferred reminder submission process. The submitter initiates the submittal by contacting the reminder server 100 in any convenient way as explained. The caller is identified 205 such as by password or by using telephony services such as caller ID and others that can check the caller origin telephone or location against a list of trusted submitters. This validation also prevents nuisance reminders by unscrupulous promoters, and the like. The target subscriber is also identified 210. This is done, as the preferred embodiment is adapted to for example provide reminders for each household member, or in another embodiment the reminder server 100 serves a large subscriber community.

If the subscriber is known 215, and the submitter has been authenticated 220 as one allowed to submit reminders for the subscriber, the reminder data is received 225. If the caller is not authenticated but, the subscriber allows unauthenticated calls the data is received 225. Otherwise the process exits 240, preferably after explaining to the caller that he/she is not authorized to submit reminders for this subscriber.

The step of receiving data 225 is also a convenient step for selecting options 250, such as options for repeating the reminder according to some schedule, selecting telephone numbers to attempt to deliver the reminder, selecting an emergency default, and the like. An emergency default option is a delivery address, by telephone, computer, wireless and the like, where if a reminder can not be delivered after a certain set of attempts, a message reporting the failure is delivered. Thus for example a typical reminder delivery sequence may comprise: ring at subscriber home, call subscriber cell phone, call subscriber neighbour, if none answered—call emergency default, and report failure to deliver.

Once all the details of reminder have been verified (existing dates, and the like) the reminder is received 230 the data is stored 235 and the process exits.

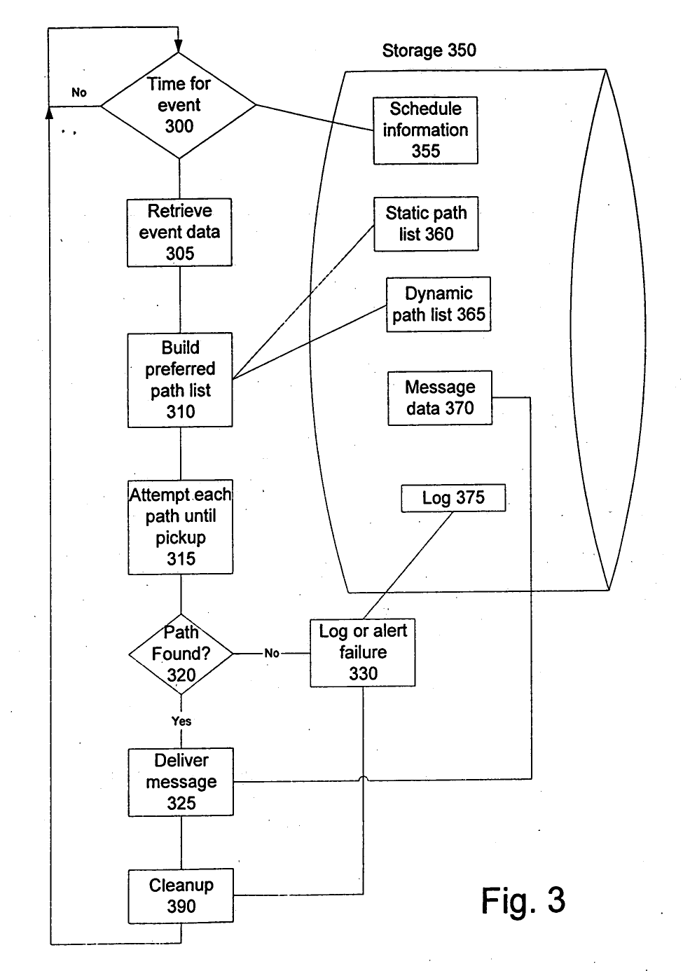

FIG. 3 depicts delivery of a reminder. According to the schedule information 355, at or about the time for delivering the reminder event 300 the event data is retrieved. A preferred path list is created 310. Such list may comprise a static path list 360, but preferably also allows a dynamic path list 365 specified at reminder submission time. While a default list may for example simply specifies the subscriber premises and then the subscriber cell phone, if the submitter knows for example that the subscriber is more likely to be away from home, the order may be changed to attempt calling the cell phone first.

Once the preferred path list is created each path is attempted for a certain time. By way of example, the phone in the subscriber premises may ring, preferably with a distinctive ring tone, for up to one minute. If no extension was picked up, a cell phone number may be tried for two minutes. If no answer was received from the cell phone, a friend's telephone number may be called, and the like. Optionally, the intended subscriber is also identified, e.g. by a server generated notification, if the answering telephone is not included in the static path list.

If path was found 320, i.e. a the call was picked up, the message may be delivered 325. Once the message is delivered, cleanup 390 is performed that may include removal of the scheduled message, logging successful reminder delivery 330 and the like.

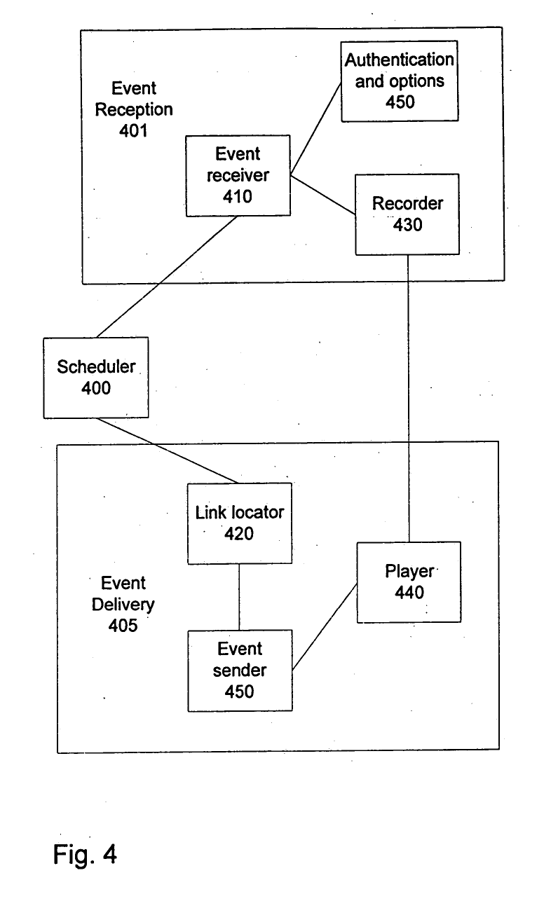

FIG. 4 depicts a general block diagram of the reminder submission and delivery portion, in accordance with the preferred embodiment. Event reception block 401 includes the event receiver adapted to receive reminder events, and coordinate user and subscriber authentication, as needed, record the message using recorder 430, and communicate the event to scheduler 400. The scheduler, which may be split in functionality between the event reception block 401 and the event delivery block 405, is responsible for timewise coordination of the event delivery. When the scheduler detects that the an event should be delivered it transfers data to the event delivery block 405 which includes a link locator 420 to build the desired path list as described above, and attempt to establish communication with the subscriber. Once communication is established, event sender 450 uses the player 440 to deliver the reminder.

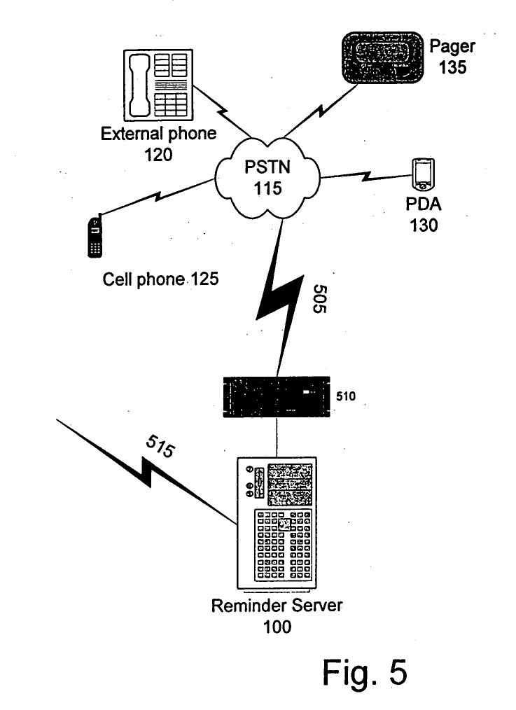

FIG. 5 depicts another embodiment of the invention. A reminder server 100 is coupled 505 to a telephony network such as telco network 115, pbx, and the like. Alternatively the reminder server is also connected to a data network 515, either by a dedicated device interface, or via telephone link. Such server may be utilized for providing reminder services to a large group of subscribers. As such server is likely to be centrally located, the telephony interrupter described above is not needed. However, a high capacity telephony system interface 510, either internal or external to the reminder server 100 is used to allow the reminder server to handle a large call volume. The operation of the centralized server will be clear from the description provided above.

This embodiment may best be utilized by a common carrier telephone provider or by a central service provider. Reminder server 100 comprises essentially of many similar component. However as the communication occurs with a plurality of telephone channels, a more robust telephony interface 510 is required. Such interface is well known in the art and is very similar to the interface used in automated voice or touch-tone navigation, voice messaging, PBX, and the like. The interface may comprise for example a CSU/DSU unit, to couple a high capacity link such as a T1/E1, T3/E3, OC12, OC48, and the like. The telephony interface may also be coupled to, or integrated with the backbone of a telephony system, e.g. an SS7 device such as SSP (Service Switching Point), STP(Signal transfer point), or an SCP (Service Control Point). Technologies used for touch-tone navigation, voice messaging, voice navigation, and the like are clearly useful in this embodiment. Input may be provided by any telephone coupled to the PSTN 115, such as telephone 120, cell phone 125, personal or mobile computer 130, or any device that may establish communications with the server 100.

FIG. 6 depicts a simplified layout showing a preferred embodiment of the invention interposed between the house service entry point and the house telephony network.

Optionally and preferably, the invention further comprises the ability to communicate with common programs used for scheduling such as personal information managers, resource management programs, and the like. Thus a schedule relating to one or more persons may be transferred from Microsoft Outlook® for example to a reminder server, by way of filtering events and sending events meeting criteria to the reminder server by a data network or a telephone network.

As a voice recorder and a voice player, together with the logic to respond to keypad data are available, an automatic answering device may easily be built, where if an incoming call is not answered for a certain period of time is not answered, the reminder server answers and records the message. No scheduling information is required, but the subscriber can retrieve the message at will.

It will also be desirable to provide remote access to organized schedule. A text to voice converter may be implemented to facilitate such access. Thus for example the subscriber (or otherwise authenticated user) may call the reminder server and request the schedule for a specific time period. A text to speech module can then read to the user the schedule for that time period.

It will be clear to those skilled in the art that the logical divisions provided above are but one example of how to make the invention, and that one skilled in the art would be able to divide the provided functionality in many ways, given the flexible nature of electronics, computer and server. However the invention is clearly directed at covering such modifications and equivalents as will be clear to those skilled persons, and not limited to the logical block arrangement, or other aspects of the description and drawings provided by way of none limiting example only.

I claim

1. An automated reminder apparatus comprising:
a telephony system interface;
an event receiver adapted to receive a plurality of reminder submissions via said telephone system interface, each submission comprises at least information related to a delivery time and a message, and directed to a subscriber that has at least one telephone device associated therewith;
a scheduler adapted to produce an activation signal at said delivery time;
and an event dispatcher, coupled to said scheduler and adapted to connect to said telephone device and deliver said message as voice message, responsive to said activation signal.

2. An automated reminder apparatus as claimed in claim 1, further comprising a voice recorder adapted to record said message.

3. An automated reminder apparatus as claimed in claim 1, wherein the apparatus is constructed to receive one reminder submission for more than just one person, thus allowing a single message to be addressed to a group of individual subscribers.

4. An automated reminder apparatus as claimed in claim 1, wherein said delivery time information is entered via speech to text analysis.

5. An automated reminder apparatus as claimed in claim 1, wherein said delivery time information is entered via a telephone keypad.

6. An automated reminder apparatus as claimed in claim 1, wherein said event receiver is constructed to prompt entry of the submission information using voice prompt.

7. An automated reminder apparatus as claimed in claim 1, wherein said event receiver is further adapted to receive reminder submissions, and management information from a data network.

8. An automated reminder apparatus as claimed in claim 1, wherein said event receiver is constructed to accept scheduling information for repeated sending of same message according to a predetermined schedule.

9. An automated reminder apparatus as claimed in claim 1, further comprising an authentication manager for performing at least operation from a list consisting of authenticating a submitter, authenticating the subscriber, and authenticating the submitter's authority to send the reminder to one or more telephone devices.

10. An automated reminder apparatus as claimed in claim 9, wherein said authentication manager is adapted to authenticate a submitter or a subscriber, or a combination thereof, utilizing caller ID information.

11. An automated reminder apparatus as claimed in claim 1, wherein said event dispatcher is adapted to attempt delivery of said message to each of a plurality of telephone devices associated with the subscriber until said message is successfully delivered.

12. An automated reminder apparatus as claimed in claim 1 wherein said event dispatcher is adapted to attempt delivery of said message to each of a plurality of telephone devices associated with said message, until said message is successfully delivered.

13. An automated reminder apparatus as claimed in claim 11, wherein if said message is not successfully delivered, a message notifying of the failure is sent to a telephone device.

14. An automated reminder apparatus as claimed in claim 1, further comprising a second telephony interface to couple to at least one telephone at the subscriber premises.

15. An automated reminder apparatus as claimed in claim 14, further comprising a ring generator having a ring output, and the apparatus is constructed to apply the ring output to the second telephony interface for delivery of message a telephone within the subscriber premises.

16. An automated reminder apparatus as claimed in claim 1, further comprising software to cause said apparatus to function as an automatic answering device.

17. A method for providing reminders using a telephone, the method comprising the steps of:
receiving a reminder submission, comprising at least a desired delivery time, and a message, in an apparatus coupled to a telephony network, said submission entered via a telephone, and directed to a subscriber having at least one telephone device associated therewith;
at substantially the desired delivery time, delivering said message to said subscriber via said telephone device.

18. A method for providing reminders using a telephone as claimed in claim 17, wherein said message is a voice message, and further comprising the step of recording said message.

19. A method for providing reminders using a telephone as claimed in claim 17, wherein said telephone device is one of an ordered list of a plurality of telephone devices associated with said subscriber.

20. A method for providing reminders using a telephone as claimed in claim 19, wherein said step of delivering further comprises the step of sequentially attempting to deliver said message to each of said plurality of telephone devices, until said message is delivered.

21. A method for providing reminders using a telephone, the method comprising the steps of:
coupling a reminder server to a telephony network;
receiving a reminder submission, comprising at least a desired delivery time, and a message, in said reminder server, said submission entered via a telephone, and directed to a subscriber having at least one telephone device associated therewith;
at substantially the desired delivery time, delivering said message to said subscriber via said telephone device.

22. A method for providing reminders using a telephone as claimed in claim 21, wherein said message is a voice message, and further comprising the step of recording said message.

23. A method for providing reminders using a telephone as claimed in claim 21, wherein said telephone device is one of an ordered list of a plurality of predetermined telephone devices associated with said subscriber.

24. A method for providing reminders using a telephone as claimed in claim 23, wherein said step of delivering further comprises the step of sequentially attempting to deliver said message to each of said plurality of predetermined telephone devices, until said message is delivered.

25. A method for providing reminders using a telephone as claimed in claim 24, further comprising the step delivering a message to a telephony device not in said ordered list, if delivery to the telephony devices on the list is not successful.

26. A method for providing reminders using a telephone as claimed in claim 21, wherein said step of receiving the desired delivery time utilizes speech to text conversion technology.

27. A method for providing reminders using a telephone as claimed in claim 21, wherein said reminder server is integrated within said telephony network.

28. A method for providing reminders using a telephone as claimed in claim 21, wherein said reminder server is integrated within an SS7 node.

29. A method for providing reminders using a telephone as claimed in claim 21, further comprising the step of authenticating the submitter.

30. A method for providing reminders using a telephone as claimed in claim 21, wherein said desired delivery time comprises a schedule of desired delivery times.

31. A method for providing reminders using a telephone as claimed in claim 21, wherein said step of receiving further comprises the step of prompting for entry of the submission information using voice prompt.

32. A method for providing reminders using a telephone as claimed in claim 21, wherein said step of receiving utilizes speech to text conversion technology.

33. A method for providing reminders using a telephone as claimed in claim 21, wherein said message comprises a voice message

34. A method for providing reminders using a telephone as claimed in claim 21, wherein said message comprises a voice message and further comprises the step of recording said message.

35. A method for providing reminders using a telephone as claimed in claim 21, further comprising the step of communicating information regarding said reminder to a personal information manager program, or to a resource management programs.

36. A method for providing reminders using a telephone as claimed in claim 21, further comprising the step of automatically presenting information about a schedule of a subscriber, in response to a telephone call inquiry.
